(19) United States
(12) Patent Application Publication
(10) Pub. No.: US 2006/0254287 A1
(43) Pub. Date: Nov. 16, 2006

(54) Cold compressed natural gas storage and transporation

(76) Inventors: Ralph Greenberg, Santa Rosa, CA (US); David Vandor, Tarrytown, NY (US)

Correspondence Address: LAW OFFICE OF MICHAEL A. BLAKE, 112 BROAD STREET, MILFORD, CT, 06460, US

(21) Appl. No.: 11/131,122

(22) Filed: May 16, 2005

(51) Int. Cl. F17C 13/00; F25J 1/00

(52) U.S. Cl. 62/50.6

(57) ABSTRACT

A method of transporting or storing a natural gas. The method comprises: compressing and chilling the natural gas; changing a state of the natural gas into a cold compressed state; pumping the natural gas to an appropriate transportation pressure or storage pressure and maintaining the natural gas in the cold compressed state. A system for the transportation of a cold compressed natural gas. The system comprises: a liquid natural gas source; a cryogenic pump in fluid communication with and adjacent to the natural gas source; a cold compressed natural gas pipeline in fluid communication with the first cryogenic pump; a plurality of cryogenic pumps in fluid communication with the cold compressed natural gas pipeline and interspersed along the cold compressed natural gas pipeline; a vaporizer in fluid communication with the cold compressed natural gas pipeline and located adjacent to an intersection of the cold compressed natural gas pipeline with an end user; and at least one refrigeration apparatus in communication with the cold compressed natural gas pipeline, configured to maintain the natural gas in the cold compressed natural gas pipeline at about a cold compressed state.

### TECHNICAL FIELD

This invention relates to the storage and transportation of compressed natural gases. In particular, the present invention relates to methods and systems for storing and transporting cold compressed natural gas.

### BACKGROUND

There are only two current commercially viable methods for storing large quantities of natural gas: 1) As a gas at ambient temperatures and high pressures, in spent gas fields and in solution-mined salt caverns, as well as within the pipelines that serve to transport the gas from the production or storage source to end users; and 2) As LNG contained in field-erected aboveground insulated storage tanks, at low pressures (under 65 psia) and cryogenic temperatures approaching −255° F.

The storage of warm natural gas at high pressures is not feasible in aboveground containers because of safety concerns and because only small amounts of product can be contained in reasonably sized containers at the relatively low pressures that can be sustained in aboveground vessels.

Warm gas storage is limited to underground facilities at spent gas fields and solution-mined salt caverns. The siting of such natural and man-made underground containers is constrained by the need to have the appropriate geological condition (spent gas field or solution-mined cavern) coincide with a pipeline distribution system that links the storage facility to its customers. Also, a storage facility that, for example, serves the northeast of the US must be in the northeast; otherwise pipeline capacity constraints during high-demand periods would undermine the quick and dependable link between the storage service and its customers.

Storage capacity is measured in billions of cubic feet (BCF). It is at that scale that the investment required to create an operational gas storage facility may be cost-effective. Because the density of warm natural gas, even at pressures as high as 2,700 psig is only 8.3 pounds per cubic feet, it requires large gas fields or solution-mined salt caverns to achieve the 1-BCF or greater “critical mass” required for commercial viability.

By contrast, the density of LNG (approximately 26 pounds per cubic feet) allows 1-BCF of product to be stored in one-third the volume required for warm gas storage. However, commercially viable LNG storage is now limited to aboveground tanks.

A pipeline-based warm gas storage facility cannot accept product from “stranded” or “shut in” wells (off-pipeline wells), and cannot deliver product to off-pipeline distribution grids. By contrast, LNG storage facilities can receive product from a variety of sources and serve local gas grids that are not connected to regional gas distribution networks.

On the operational side, high-pressure warm gas storage facilities need to be located deep underground if the high-pressure gas is to be contained without losses. Selecting a shallow facility, with less overburden, would not allow as much storage pressure, further reducing the total density of the product. In order to “deposit” the gas under high-pressure, large compressors must be used to quickly boost the pipeline-delivered gas-pressure to storage-pressures.

During outflow, as pressure in the storage facility drops, the same compressors are used to boost the outflow gas pressures to pipeline-pressures. In short, warm gas storage has significant capital and operating costs related to gas compression.

By contrast, storage facilities associated with LNG import terminals utilize the energy input (refrigeration) that is inherent in the stored product. The energy input required for refrigeration is “contributed” where the LNG is produced. The extra cost of refrigeration (and shipping) is offset by the lower cost of the feed gas, allowing the delivered product to be competitive with pipeline natural gas. Without the refrigeration input and the resultant “transportability” outside the pipeline system, the feed gas that is to become LNG would have a much-reduced market value.

The need for large compressors is eliminated when the product that is moved in or out of storage is in a liquid phase. Instead of compressors, cryogenic pumps are used, which are significantly less costly to purchase and operate than compressors that will move the same amount of product.

Warm gas storage needs to maintain a significant amount (up to 30%) of “cushion gas” in storage, as a pressure maintenance technique. That cushion gas can never be recovered. This is not a constraint on the storage of LNG or near-liquid natural gas, which does not require the maintenance of high storage pressures or large volumes of cushion gas.

In addition to imported LNG, the US fuel supply chain also includes LNG made at on-shore plants using North American pipeline gas as a feedstock. The major benefit of LNG is its reduced volume, which yields off-pipeline transport options and aboveground storage options. At a temperature of, say, −255° F., and a pressure of 50 psig, LNG has a density of 26.1 pounds per cubic feet, which is 3.14 times the density of high-pressure warm gas. At such a higher density (and reduced volume), LNG storage solves many of the constraints on warmed gas storage, but not all, and has its own set of distinct storage and transport limitations.

All imported LNG that is not immediately vaporized into pipelines upon arrival at the import terminal, and all domestically produced LNG, are stored and kept in liquid form in large above-ground insulated storage tanks until vaporization and pipeline insertion is required or until the LNG is transferred to and shipped in insulated rail cars or trailers to off-site customers.

LNG imported by ship from sources outside the United States, is a relatively small but increasing source of US fuel consumption. However, there are several logistical constraints to the continued growth of that fuel source, including the following items: 1) a limited number of LNG import terminals; 2) limited on-site LNG storage capacity in above-ground tanks; and 3) the inability to cost-effectively transport LNG in pipelines over any significant distance. Item 1) is currently being addressed by applications to the Federal Energy Regulatory Commission (“FERC”) for the construction of new import terminals or the enlargement of existing ones. However, more import terminals will not, by themselves, solve the other two constraints listed above.

Item 2) is difficult to overcome at urban facilities, e.g. the Everett Mass. import terminal, because of the need for fairly large sites with appropriately sized buffer zones. At non-urban locations, new aboveground LNG tanks may be feasible. However, due to security concerns, especially after Sep. 11, 2001, the permitting process for large LNG tanks is likely to become more complex as new applications are put forth. Local objections to new import terminals and to large aboveground LNG tanks are related to the perceived “risks” associated with LNG tankers and with highly visible LNG storage tanks.

Item 3) requires a cost-effective technical solution. The most significant benefit of moving LNG by pipeline is that LNG is dense and requires a pipeline with a significantly smaller cross section to move as much product as in high-pressure warm-gas lines. Toward that end and to link insulated LNG tanker loading/unloading facilities with insulated LNG storage tanks, insulated cryogenic pipelines are used at LNG import/export terminals, but only over short distances. For longer runs, there are major technical and economic constraints on the transport of LNG by pipeline.

Transporting LNG in closed vessels, such as trailers, rail cars, or ships, is a well-developed technology. Pumping LNG to pressure and moving it over a short distance in insulated pipelines is also well understood. However, the long-distance transport of LNG by pipeline is constrained by the tendency of the LNG to form a two-phase fluid (liquid and gas) as it gains heat through the pipeline walls and looses pressure through friction between the moving natural gas and its “container”.

The smooth flow of LNG changes to an unsteady “slug flow” as the two phases form. The sluggishness is caused by the interaction of the liquid and gas phases. As the natural gas's flow rate slows down and as its temperature rises, the pressure required to move the product will rise dramatically. Mitigation by frequently placed re-refrigeration units along the LNG pipeline, with large refrigeration outputs (as measured by Tons of Refrigeration or “TR”) is not cost-effective.

Attempts at limiting heat gain, and avoiding the two-phase conditions have focused on sophisticated pipeline insulation methods, including vacuum jacketing. However, due to cost constraints and the limited effectiveness of such solutions, no long distance LNG pipelines have yet been built.

Storing LNG at low pressures in closed, highly insulated aboveground LNG tanks and in transport vessels such as trailers, rail cars, and ships is a well-developed technology. However, the longer-term storage of LNG in large (1-BCF or more) underground containers has not been demonstrated to be commercially viable. The following are the two main obstacles to storing large quantities of LNG in underground containers: 1) LNG may be too cold for conventional underground cavern storage, causing tensile and compression stress failures in the geological formations that surround the storage cavern. Such cold-induced stress failures can destroy the cavern's ability to contain the stored product, especially as the pressure in the cavern rises due to heat gain. 2) The construction of large, conventional, field erected LNG tanks in near-surface excavations and with earth covered roofs, is difficult because of the need to insulate the interface between the surrounding earth and the tank, (to avoid frost heave), and because the earth-covering of such a large (1-BCF or greater) field-erected LNG tank creates significant structural and cost issues related to the long span of the roof and the weight of the earth. The roof structure must not only resist the increasing (dynamic load) upward pressure of the vapor cloud that forms above the warming LNG but it must also support the significant additional weight (static load) of the covering earth.

The storage of LNG in underground facilities, such as in solution-mined salt caverns, has not been demonstrated as viable. The temperature range of LNG, −200° F. to −255° F., depending on the pressure it is contained at, causes a major geo-mechanical challenge. That temperature range is colder than the salt cavern walls and its salt-stone, shale, limestone or dolomite ceiling will likely tolerate. The compression and tensile stresses caused by the deep refrigeration, even if applied slowly over time, will likely cause fractures that will propagate to significant distances outward from the cavern, causing slabs of the walls and/or ceiling a to collapse into the cavern, possibly destroying the inflow and outflow piping and causing the cavern to loose its capacity to contain the LNG and the vaporized gas cloud above it.

Still, warm gas is routinely stored at pressures of 2,000 psig and greater in solution-mined salt caverns located at depths of more than 3,000 feet below the surface. Based on that model, one can ask: “Why can't relatively warm LNG (warmer than −190° F.) be stored that way?

Even if the cavern's geology were able to withstand cryogenic temperatures that were never colder than −190° F., there are inflow and outflow challenges to storing LNG in underground caverns. Pouring LNG down a cryogenic tube is fairly simple. Bringing it back to the surface is more difficult. The heat of geological pressures at deep caverns (3,000 feet and deeper) is in excess of +100° F. At those temperatures, heat gain through the cavern walls will cause the stored LNG to quickly become a two-phased fluid, consisting of liquid methane under a vapor cloud.

During outflow, pressure relief valves on the surface will only allow the release of a relatively small amount of the low-pressure vapor cloud. As outflow continues and as the cavern's vapor cloud content is diminished, pressure within the cavern will fall and some of the gas will return to a cold liquid phase. The temperature of that “newly” formed LNG may be colder than the cavern can tolerate. Also, using a pressure relief valve to bring product to the surface will not allow the vast majority of the stored product to be recovered.

Other methods, of moving product from the cavern to the surface, such as down-hole cryogenic pumps have not been demonstrated in deep underground modes. Several technical issues need to be resolved for down-hole pumping to be viable. For example, the diameter of the pumps and the casing that connects the surface infrastructure with the bottom of the cavern would need to be coordinated. The well casing would need to be large enough to allow for the lowering of the pump(s) into the cavern. Also, the piping that connects the surface and the down-hole pump would need to allow for periodic maintenance of the pump, including its removal from a deep, down-hole position. Also, the pump would need to be mechanically anchored, deep in the cavern, so that it does not spin while in operation.

There are no known underground cavern storage facilities that store LNG. The paucity of examples of LNG storage in deep underground containers suggests that the technical and economic issues of such a model have not yet been resolved.

Therefore a method and apparatus that overcomes the above-listed and other disadvantages in the transportation and storage of natural gas is needed.

### SUMMARY

An embodiment of the disclosed method relates to transporting a natural gas. The method comprises: compressing and chilling the natural gas; changing a state of the natural gas into a cold compressed state; pumping the natural gas to an appropriate transportation pressure and maintaining the natural gas in the cold compressed state.

The disclosed system relates to the transportation of a cold compressed natural gas. The system comprises: a liquid natural gas source; a cryogenic pump in fluid communication with and adjacent to the natural gas source; a cold compressed natural gas pipeline in fluid communication with the first cryogenic pump; a plurality of cryogenic pumps in fluid communication with the cold compressed natural gas pipeline and interspersed along the cold compressed natural gas pipeline; a vaporizer in fluid communication with the cold compressed natural gas pipeline and located adjacent to an intersection of the cold compressed natural gas pipeline with an end user; and at least one refrigeration apparatus in communication with the cold compressed natural gas pipeline, configured to maintain the natural gas in the cold compressed natural gas pipeline at about a cold compressed state.

Another embodiment of the disclosed method relates to the storing a natural gas. The method comprises: compressing and chilling a natural gas; changing a state of the natural gas into a cold compressed state; pumping the natural gas to an appropriate storage pressure; pumping the natural gas into a storage container; and maintaining the natural gas in the cold compressed state.

A still other embodiment of the disclosed method relates to storing a natural gas. The method comprises: pumping a liquid natural gas to a cold compressed state; and maintaining the natural gas in a cold compressed state.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a phase diagram for methane and natural gas;

FIG. 2 is a schematic diagram showing a system of transporting cold compressed natural gas;

FIG. 3 is a flowchart illustrating one disclosed method of transporting cold compressed natural gas;

FIG. 4 is a flowchart illustrating one disclosed method of storing cold compressed natural gas; and

FIG. 5 is a flowchart illustrating a disclosed method of storing or transporting cold compressed natural gas.

### DETAILED DESCRIPTION

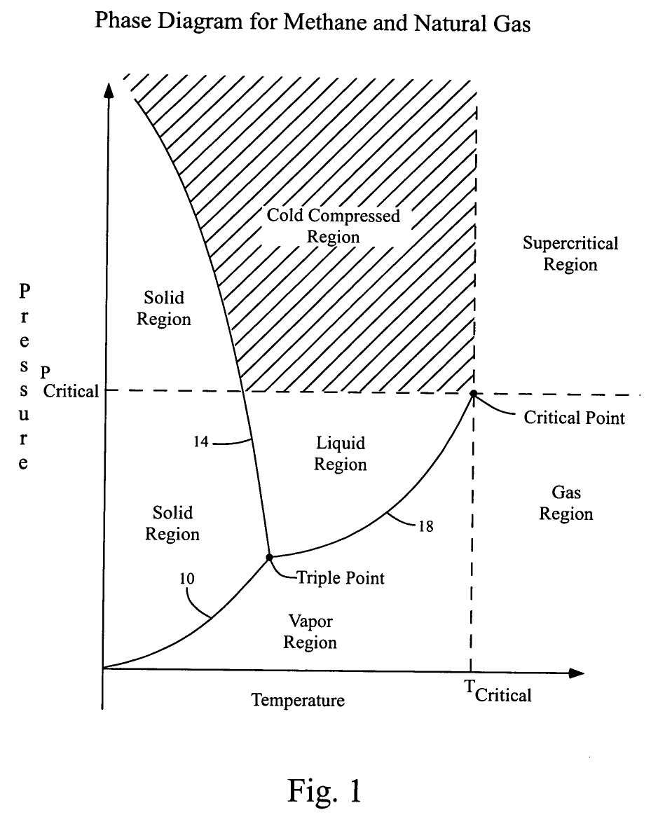

FIG. 1 is a phase diagram for methane and natural gas. Although this patent application discusses the invention with respect to natural gas and various compositions of natural gas, one of ordinary skill in the art will understand that the disclosed application applies also to methane, a main component of natural gas. Methane and natural gas are similar but not identical. Typical natural gas contains about 94% methane, 3% heavier hydrocarbons and 3% CO₂ plus nitrogen as well as small quantities of water and sulfur compounds. CO₂, water and sulfur are usually removed prior to chilling the natural gas to prevent freeze-out. The phase diagram, FIG. 1, can apply to natural gas because it is qualitative in nature. Specific values for critical pressure and critical temperatures discussed in this patent application are for pure methane, however, it will be obvious to those of ordinary skill that slightly different values for critical pressure and critical temperature will be used for natural gas, the exact values will be dependant on the composition of the particular natural gas. At the triple point, the natural gas can exist as a solid, vapor and liquid. A solid-vapor coexistence curve 10 extends downwards and leftwards from the triple point. A solid-liquid coexistence curve 14 extends generally upwards from the triple point. A liquid-vapor coexistence curve 18 extends upwards and rightwards from the triple point up to the critical point. It is generally accepted that above the critical temperature (“T_{CRITICAL}”) and above the critical pressure (“P_{CRITICAL}”) for a composition, it exists in a supercritical state. The region above the critical temperature and above the critical pressure shall be referred to the as the supercritical region, and fluids within that region shall be referred to as supercritical fluids. The region to the left of the supercritical region, that is, the region above the critical pressure, and below the critical temperature, and to the right of the solid-liquid coexistence curve shall be referred to as the cold compressed region in this disclosure, and fluids within that region shall be referred to as cold compressed fluids. The cold compressed region is indicated by the hatch marks in FIG. 1. Fluids in the supercritical region have unique properties, including existing as a single phase fluid. Fluids in the cold compressed region have some of the same characteristics of supercritical fluids, including existing as a single phase fluid. Additionally, fluids in the cold compressed region have densities approaching that of LNG. It should be noted that fluids in the cold compressed region are not technically in a liquid phase, but are technically in a gas phase.

Transportation of Cold Compressed Natural Gas

The cold compressed state of a natural gas can be achieved by pumping LNG above its critical pressure and maintaining its temperature within a range that is colder than the critical temperature. The cold compressed state is dependent on both temperature and pressure. Specifically, at about −116° F. and all colder temperatures up to about the solid-liquid coexistence line 14 and at about 693 psia and all higher pressures, the cold compressed natural gas is both cold enough and compressed enough to allow its single-phase, “slug-free” transport by pipeline. Please note that the temperature value of −116° F. and pressure value of 693 psia are the critical temperature and pressure of methane respectively. One of ordinary skill in the art will recognize that different values for critical temperature and critical pressures will be used for other compositions of natural gas.

Within those temperature and pressure ranges, the natural gas will maintain near liquid densities and gas like viscosities.

Within a relatively wide range of temperatures and pressures, cold compressed natural gas will remain in a single phase, with a density (as measured in pounds per cubic feet) that will be no less than approximately 85% of LNG. In that dense single phase it will travel smoothly through a pipeline, over longer distances, even as it gains heat, as long as the natural gas's temperature is about −116° F. or colder (up to about the solid-liquid line 14) and its pressure is about 693 psi or greater. Again, the temperature value of −116° F. and pressure value of 693 psia are the critical temperature and pressure of methane respectively. One of ordinary skill in the art will recognize that different values for critical temperature and critical pressures will be used for other compositions of natural gas. Gas in its cold compressed state will move through a moderately insulated cryogenic pipeline without “slug flow” or “sluggishness”, yielding a much lower pressure drop as the product moves through the pipeline, and requiring less frequent booster refrigeration and pumping stations.

Cold compressed natural gas can be pumped through a cryogenic pipeline, insulated with standard industrial insulation. Cryogenic pumping stations at about approximately 50-mile intervals, (rather than compressor stations) will allow for pipeline pressure maintenance and transport. Pumping a liquid natural gas (or a cold compressed natural gas) requires significantly less energy input than compressing a warm gas. Because of the near-LNG densities of the product, a 12 inch cold compressed natural gas pipeline will move as much natural gas as a standard 24 inch pipeline.

For pipeline runs greater than about 150-miles, the cold compressed natural gas will need to be re-chilled in order to offset heat gain, which, if allowed to build up, may warm the gas to warmer than about −100° F., causing it to behave more like ordinary compressed natural gas. However, the supplemental refrigeration need not chill the −100° F. cold compressed natural gas back down to LNG temperatures (about −255° F.), but only to the relatively warm temperature range of its cold compressed state.

The source LNG can easily be pumped to about 1,500 psi, thus allowing for a set of cold compressed natural gas conditions with a relatively high range of temperatures and pressures. That wide range of conditions allows for a much higher pressure drop than might be considered in a “standard” LNG pipeline, offering several significant advantages including the following: the location of cold compressed natural gas pumping stations can be located significantly further apart than would be possible for a standard LNG pipeline; the cold compressed natural gas does not need to be cooled back down to about −255° F., (as would be required for an LNG pipeline), thus allowing for lower capital and operating costs for a less frequent set of intermediate refrigeration units; by adjusting the pumping rate (pumping faster), the cold compressed natural gas's temperature rise, as it moves through the pipeline, will be proportionally reduced; and a wide range of optimizations for increasing the efficiency of the cold compressed natural gas pipeline can be evaluated, include adjustment in the pumping pressure and pumping rate, the distance between pumping stations, and the thickness and quality of the pipeline insulation.

The capital costs and energy input required to build and to operate a cold compressed natural gas pipeline will be the same or lower than a standard pipeline carrying the same quantity of warm gas under pressure. An advantage of the cold compressed natural gas pipeline is its ability to connect the following with shore-based import terminals: Inland LNG/cold compressed natural gas storage facilities; Inland customers for LNG, including power plants and large industrial gas customers that need on-site peak shaving and back up fuel options; Regional natural gas distribution lines that do not run close to the import terminals; and Rail yards and truck depots, where piped cold compressed natural gas can be cost-effectively re-liquefied to LNG for transport to off-pipeline natural gas grids, thus extending the natural gas market to areas where new pipeline construction is not feasible.

A comprehensive cold compressed natural gas pipeline transport system may consist of the following, starting at the LNG import terminal (or pipeline-based LNG plant) and ending at an inland cold compressed natural gas storage site, transfer point, or at a major pipeline distribution hub: 1. Cryogenic pumps at the LNG source and at reasonable intervals along the pipeline; 2. A vaporizer/warmer at the intersection of the cold compressed natural gas pipeline and an end-user or at a standard pipeline; 3. Cryogenic pipeline segments designed to withstand pressures of up to about 1,500 psig, and insulated with foam insulation to resist heat gain; and 4. Supplemental refrigeration equipment at reasonable intervals along the pipeline, at cold compressed natural gas storage sites, and at locations where the cold compressed natural gas needs to be re-chilled to LNG for off-pipeline distribution or for storage in above ground LNG tanks.

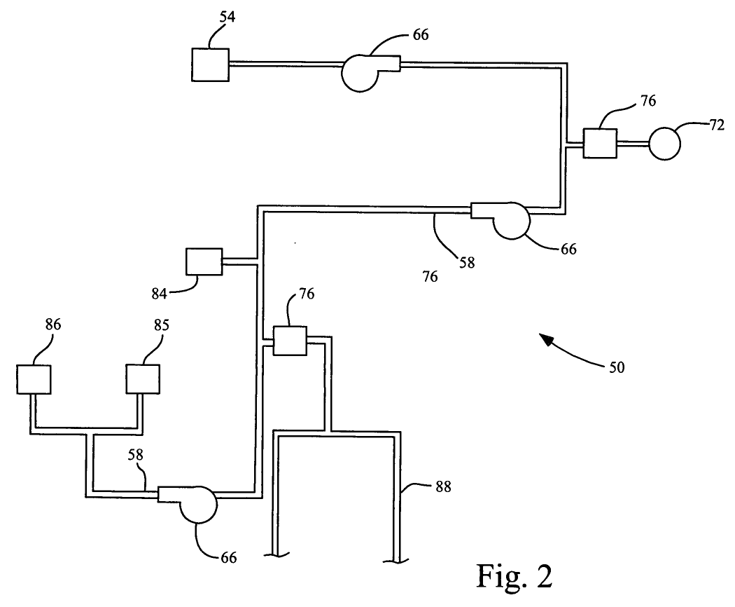

FIG. 2 is a schematic of a pipeline system 50 for transporting cold compressed natural gas. A liquid natural gas source 54 is in fluid communication with a pipeline 58. The liquid natural gas source 54 may be an LNG storage tank, or an LNG transport ship. The natural gas source 54 is also in fluid communication with a first cryogenic pump 66. The pump 66 is in relatively close proximity with the natural gas source 54. One end user 72 is shown in communication with the pipeline 58. Adjacent to the end user 72, a vaporizer or warmer 76 is in fluid communication with the pipeline 58. There may be one or more end users 72 and vaporizers or warmers 76 distributed along the pipeline 58. Distributed at regular intervals along the pipeline 58, are other cryogenic pumps 66. Additionally, a refrigeration apparatus 84 is in fluid communication with the pipeline 58. In one embodiment, there may be a refrigeration apparatus 84 for every length of pipeline 58 of about 400 miles to about 500 miles. If the pipeline 58 is in communication with a pipeline 88 transporting non-cold compressed natural gas, then a vaporizer or warmer 76 is located proximate to an intersection between the pipeline 58 and the pipeline 88. The vaporizer or warmer 76 is in fluid communication with the pipeline 58 and the non-cold compressed natural gas pipeline 88. A pressure letdown station 85 for LNG production may be in fluid communication with the pipeline 58. Additionally, the pipeline 58 may be in fluid communication with a cold compressed natural gas storage facility 86. The storage facility may be an underground cavern, or an above ground tank.

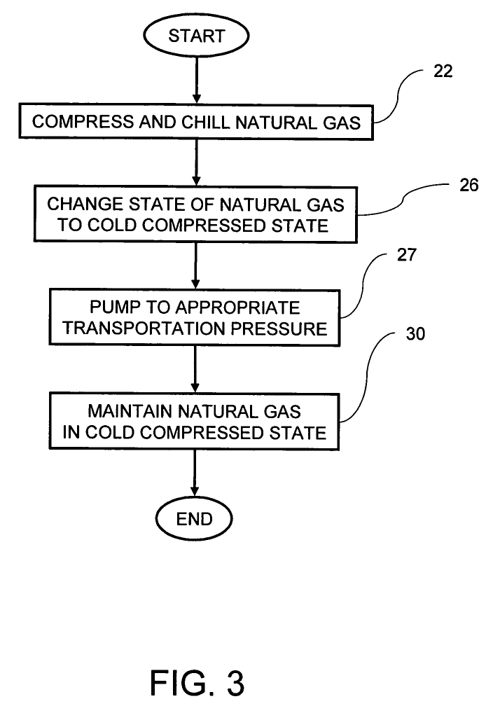

FIG. 3 shows one embodiment of a disclosed method of transporting cold compressed natural gas. At act 22, a natural gas is compressed and chilled. At act 26, the natural gas' state is changed to a cold compressed state. At act 27, the natural gas is pumped to an appropriate transportation pressure, that is, a pressure that will allow the natural gas to enter a transportation apparatus, such as a pipeline. At act 30, the natural gas is maintained in a cold compressed state.

Storage of Cold Compressed Natural Gas

Instead of storing LNG as a liquid, which will quickly form a two-phased fluid, it may be converted, prior to storage, to a single-phase, cold compressed gaseous natural gas within specified temperature and pressure ranges. In that state it will be approximately 85% as dense as LNG and suitable for storage in solution-mined salt caverns and other natural and man-made storage configurations.

For example, for storage in solution-mined salt caverns, the single-phase natural gas can be kept warm enough (between about −116° F. and about −150° F.) so that the salt cavern will not be overly stressed. The natural gas will be at a high-enough pressures (about 693 to about 2,000 psia) so that it will leave the deep cavern when a surface valve is opened, not requiring a down-hole cryogenic pump. The selected pressure range will depend on the depth of the specific cavern, but will always be about 693 psia or above. Shallow caverns (at just over about 1,400 feet in depth) will operate at or near the about 693 psia range, while deeper caverns will operate at higher pressures. (Warm gas storage fields need much greater depths to be viable.) The temperature value of −116° F. and pressure value of 693 psia are the critical temperature and pressure of methane respectively. One of ordinary skill in the art will recognize that different values for critical temperature and critical pressures will be used for other compositions of natural gas.

The cold compressed, single-phase, gaseous, high-density state of methane and or natural gas can be achieved by pumping the LNG (prior to storage) to an above-critical pressure and maintaining its temperature within a range that is colder than critical. The cold compressed state is dependent on both temperature and pressure. Specifically, at about −116° F. and all colder temperatures and at about 693 psia and all higher pressures, the cold compressed methane is both cold enough and compressed enough to allow it to be maintained in a single-phase. Maintenance of that single phase is possible by several techniques, including any one or a combination of the following: Allowing the pressure in the storage vessel to build; Inserting additional cold product; and re-chilling the warming dense gas by means of an external chiller or by heat exchange with incoming LNG. Again, the temperature value of −116° F. and pressure value of 693 psia are the critical temperature and pressure of methane respectively. One of ordinary skill in the art will recognize that different values for critical temperature and critical pressures will be used for other compositions of natural gas.

Within those temperature and pressure ranges, the natural gas will have near liquid densities and gas like viscosities.

In the absence of appropriate geological formations that are suitable for the development of solution-mined salt caverns, and as an alternative to large capacity near-surface underground LNG storage, storage vessels may be constructed that are configured to readily contain the cold compressed natural gases. A benefit of storage constructed vessels is that a storage site can be selected to be immediately adjacent to an end-user of the storage service, such as a power plant or a steel mill.

Within a relatively wide range of temperatures and pressures, the cryogenic, near-liquid cold compressed natural gas will remain in a single phase, with a density (as measured in pounds per cubic feet) that is approximately 85% as dense as LNG. However, the temperature of the product can be significantly warmer than LNG, causing less thermal stress to the container.

The pressure range of the product is significantly lower than that needed for warm gas storage, but wide enough to allow for outflow to occur by valve release at the surface, without the need for down-hole cryogenic pumps. In that single phase the product will travel smoothly through the pipe that connects the top of the cavern with the surface, arriving at the surface slightly warmer and at a lower pressure, but still in a cold compressed state. That feature will allow the product to be pumped to higher pressures before the warming required for pipeline insertion. An advantage is that this allows the product to be inserted into the pipeline at the appropriate pressure, but without the need for large, expensive and power-hungry compressors.

Recovery of almost the entire cavern's content is possible, (without the formation of colder LNG), as long as the pressure in the cavern is maintained. Pressure maintenance in a closed container is a well-understood technology that relies on recycling some portion of the outflow back into the container after some heat is added. In this way the portion of the stored gas that can be removed, known as the “working gas,” will be a very large percentage of the total capacity of the storage vessel. The corollary is that the portion of the stored gas that needs to stay in the vessel to maintain baseline temperatures and pressures (the cushion gas), will be a small percentage of the vessel's total capacity.

The pressure range for cold compressed natural gas storage, starting at 693 psig, is much lower than required to achieve any significant storage capacity for a warm gas facility. Most such underground warm gas storage systems, storing gas at densities of only about 30% of cold compressed natural gas, must operate at pressures as high as about 2,500 psig. Such high pressures are required to attain any significant quantity of storage and to allow for retrieval of the product such that surface pressures are suitable for pipeline insertion.

A high-pressure underground storage system must be deep enough to allow for the geology above it to help contain the stored product. A typical 2,500-psig warm gas storage cavern needs to be located about 3,000 feet below the surface. That constraint limits the geological options for solution-mined caverns to deep salt formations. By contrast, cold compressed natural gas can be stored at lower pressures, allowing for the use of solution-mined caverns that are only 1,500 feet below the surface, increasing the geographic range for such cavern storage.

The capital costs and energy input required to operate a cold compressed natural gas storage facility will be competitive with the costs and energy input required for high-pressure warm gas storage systems.

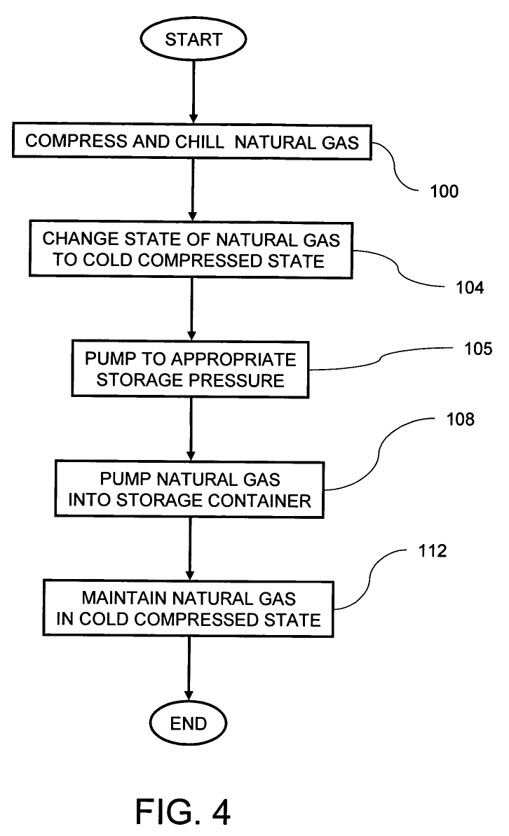

FIG. 4 shows one embodiment of a disclosed method of storing cold compressed natural gas. At act 100, a natural gas is compressed and chilled. At act 104, the natural gas' state is changed, to a cold compressed state. At act 105, the natural gas is pumped to an appropriate storage pressure, that is, a pressure where the natural gas in its cold compressed state will be able to enter the storage container. At act 108, the natural gas is pumped into a storage container. The storage container may be a cavern, a tank, or a cryogenic pressure vessel. At act 112, the natural gas is maintained in a cold compressed state.

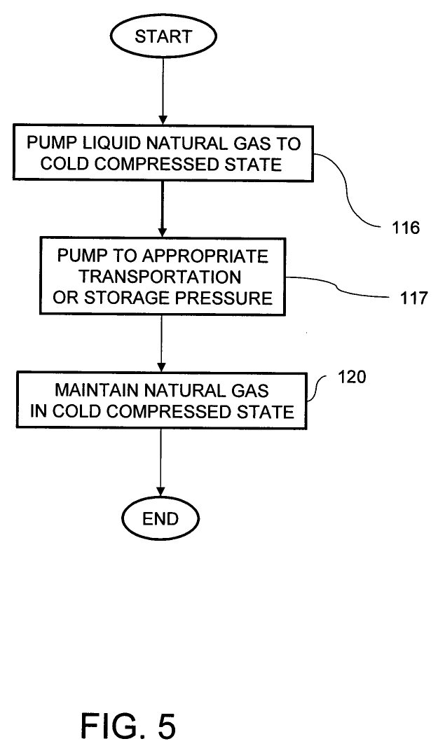

FIG. 5 shows another embodiment of the disclosed method of storing or transporting cold compressed natural gas. At act 116, LNG is pumped to a cold compressed state. At act 117 the natural gas is pumped to an appropriate pressure for either transportation or storage. That is, a pressure high enough, to allow the cold compressed natural gas to enter the transportation device, such as a pipeline, or a storage container. At act 120, the natural gas is maintained in a cold compressed state. In one cavern storage embodiment, the pumping occurs at the surface, before the product enters the vessel, and that the pumping pumps to the natural gas to above about 693 psia to achieve the cold compressed state. Then additional pumping is required to achieve a high enough pressure for the natural gas to enter the cavern. That additional pressure is dependent on the depth of the cavern.

The major advantages of storing cold compressed natural gas (as compared to warm gas) include, but are not limited to the following: 1. The energy input required to “making” cold compressed natural gas is inherent in the LNG that will be the principal source for the product. In other words, in a quest to achieve high-density storage and transportability, others provide much of the refrigeration required to make cold compressed natural gas. 2. With a density that is about 85% as dense as LNG, cold compressed natural gas is three times as dense as high-pressure warm gas. That state requires a much smaller sized storage vessel to contain the same amount of natural gas, as measured by energy content. 3. Smaller storage caverns are easier and quicker to develop. 4. A smaller solution-mined cavern will require significantly less brine removal and disposal, lowering development costs and reducing the environmental issues associated with the disposal of large quantities of brine. 5. Cold compressed natural gas can reach its storage destination by transport as LNG in rail cars or trailers, or as cold compressed natural gas by pipeline, thus avoiding the pipeline capacity issues of warm gas storage models. The “art of flashing cold compressed natural gas to LNG is well understood. 6. The option to store cold compressed natural gas at moderate pressures expands the geographic potential for locating solution-mined salt caverns in formations that are closer to the surface. By contrast, warm gas storage requires deep caverns to sustain the high storage pressures. 7. Cold compressed natural gas can be removed from storage, pumped to high pressures, warmed and inserted into regional pipeline distribution systems, without the need for large on-site compressors. Pumping of a near-liquid requires significantly less energy input than compressing a warm gas. 8. Cold compressed natural gas can be removed from storage, flashed to a low pressure and converted to 80% LNG and 20% low-pressure cold gas. Thus, a cold compressed natural gas storage facility can also dispense LNG for off-site, off-pipeline distribution. 9. Cold compressed natural gas can be made from pipeline gas, from LNG, or from a combination of LNG and pipeline gas. It offers a wider range of delivery-to-storage options (product sources) than warm gas. 10. The arrival of cold compressed natural gas to the storage site can overlap the outflow process because the same pipeline is not used both for inflow and outflow. By contrast, warm gas storage facilities cannot accept inflow deliveries during outflow cycles because the same pipeline serves both functions.

Advantages of storing cold compressed natural gas (as compared to LNG) include the following: 1. The high-density transport of cold compressed natural gas in dedicated pipelines, will allow LNG production and import sites to be “linked” to inland storage facilities and to multiple regional gas distribution lines, without giving up most of the inherent density of the LNG. By contrast, the transport of LNG is currently limited to small capacity trailers and rail cars or, after vaporization, to transport within standard natural gas pipelines. 2. Cold compressed natural gas storage system will be designed to allow for a wider temperature range than is common in LNG storage tanks, but a range that is always warmer than standard LNG. The temperature induced stresses on solution-mined caverns will thus be less than those caused by the colder LNG, allowing solution-mined caverns that, up to now, have only served to store warm gas, to store higher density cryogenic natural gas. 3. The warmer and wider storage temperature range of cold compressed natural gas will allow it to be stored in solution-mined caverns, or in man-made near surface underground containers without the need for extremely sophisticated insulation systems. Every effort must be made to avoid heat gain and boil off in LNG storage tanks. By contrast, cold compressed natural gas is already a dense gas, where boil off is not an issue, and which can gain modest amounts of heat without the need for pressure relief. 4. The cold compressed natural gas storage pressure range will be broader than the limits on LNG storage tanks. Standard LNG tank storage systems must constantly fight boil off and pressure build up (and avoid venting of product), with re-compression for pipeline disposal or re-chilling for return to the storage tank. Cold compressed natural gas storage systems will tolerate a greater degree of product warming because cold compressed natural gas will continue to be in the single phase over a broader range of pressures. Cold compressed natural gas storage trades off some product density (it is only 85% as dense as LNG) in exchange for greater flexibility in storage pressures and for the benefit of maintaining the single-phase for the natural gas. The inflow and outflow systems for a deep storage cavern are much simpler to design, operate and maintain when the stored product is a single-phase natural gas.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A method of transporting a natural gas, the method comprising:
compressing and chilling the natural gas;
changing a state of the natural gas into a cold compressed state;
pumping the natural gas to an appropriate transportation pressure; and
maintaining the natural gas in the cold compressed state.

2. The method of claim 1, wherein the maintaining act is comprised by: determining whether the natural gas is above its critical temperature; and
cooling the natural gas to below its critical temperature if the natural gas is above its critical temperature.

3. The method of claim 2, wherein the critical temperature is about −116° F.

4. The method of claim 1, further comprising:
changing the phase of the natural gas from a liquid to a gas.

5. The method of claim 1, further comprising:
compressing the natural gas to at least about 693 psia.

6. The method of claim 1, wherein the natural gas is a relatively pure methane.

7. A system for the transportation of a cold compressed natural gas comprising:
a liquid natural gas source;
a cryogenic pump in fluid communication with and adjacent to the natural gas source;
a cold compressed natural gas pipeline in fluid communication with the first cryogenic pump;
a plurality of cryogenic pumps in fluid communication with the cold compressed natural gas pipeline and interspersed along the cold compressed natural gas pipeline;
a vaporizer in fluid communication with the cold compressed natural gas pipeline and located adjacent to an intersection of the cold compressed natural gas pipeline with an end user; and
at least one refrigeration apparatus in communication with the cold compressed natural gas pipeline, configured to maintain the natural gas in the cold compressed natural gas pipeline at about a cold compressed state.

8. The system of claim 7, further comprising:
a vaporizer adjacent to an intersection of the cold compressed natural gas pipeline with a non-cold compressed natural gas pipeline, and in fluid communication with the cold compressed natural gas pipeline and the non-cold compressed natural gas pipeline.

9. The system of claim 7, further comprising:
cryogenic pipeline segments designed to withstand pressures of up to 1,500 psig and insulated to resist heat gain.

10. A method of storing a natural gas, the method comprising:
compressing and chilling a natural gas;
changing a state of the natural gas into a cold compressed state;
pumping the natural gas to an appropriate storage pressure;
pumping the natural gas into a storage container; and
maintaining the natural gas in the cold compressed state.

11. The method of claim 10, wherein the maintaining act is comprised by: determining whether the natural gas is above its critical temperature; and
chilling the natural gas to below its critical temperature if the natural gas is above its critical temperature.

12. The method of claim 11, wherein the critical temperature is about −116° F.

13. The method of claim 10, further comprising:
changing the phase of the natural gas from a liquid to a gas.

14. The method of claim 10, further comprising:
compressing the natural gas to at least about 693 psia.

15. The method of claim 10, wherein the natural gas is a relatively pure methane.

16. The method of claim 10, wherein the storage container is a cavern.

17. A method of storing a natural gas, the method comprising:
pumping a liquid natural gas to a cold compressed state; and
maintaining the natural gas in a cold compressed state.

18. The method of claim 17, further comprising pumping a cold compressed natural gas to an appropriate transportation pressure.

19. The method of claim 17, further comprising pumping a cold compressed natural gas to an appropriate storage pressure.
